(19) United States
(12) Patent Application Publication
(10) Pub. No.: US 2013/0140800 A1
(43) Pub. Date: Jun. 6, 2013

(54) Airbag

(71) Applicants: Ralf Koehnen, Cheshire (GB); David Stow, Gothenburg (SE); Hugh Finn, Cheshire (GB)

(72) Inventors: Ralf Koehnen, Cheshire (GB); David Stow, Gothenburg (SE); Hugh Finn, Cheshire (GB)

(73) Assignee: Autoliv Development AB, Vargarda (SE)

(21) Appl. No.: 13/816,654

(22) PCT Filed: Aug. 3, 2011
(86) PCT No.: PCT/EP2011/003879

§ 371 Date: Feb. 12, 2013

(30) Foreign Application Priority Data
Aug. 13, 2010 (DE) 10 2010 034 371.4

(51) Int. Cl. B60R 21/235

(52) U.S. Cl. CPC B60R 21/235
USPC 280/743.1

(57) ABSTRACT

An airbag having an outer skin enclosing at least one gas chamber is disclosed. The outer skin is made at least in parts of polymer material with the polymers of the polymer material being made by polymerisation of monomers. In order to reduce the total consumption of fossil based raw materials during the life cycle of a vehicle, at least a part of the monomers are sustainable based monomers being produced from a renewable raw material.

### CROSS-REFERENCE TO RELATED APPLICATION

This application claims priority to German Patent Application Number 10 2010 034 371.4, filed Aug. 13, 2010 and PCT/EP2011/003879, filed Aug. 3, 2011.

### FIELD OF THE INVENTION

The invention relates to an airbag for a motor vehicle and particularly to material for forming the fabric material forming an airbag.

### BACKGROUND OF THE INVENTION

As is common knowledge, motor vehicles are heavy consumers of fossil based raw materials—especially carbon and oil—during their entire life cycle, namely during their production and during their operation. As is also common knowledge the resources of fossil raw materials are limited. Thus, large efforts are made in order to reduce the total consumption of fossil based raw materials during the life cycle of a vehicle.

### SUMMARY OF THE INVENTION

This invention seeks to give a contribution to these efforts.

Most airbags used today are made of woven fabrics. The yarns of such a fabric comprise fibres made of polymers. Polymers are made from monomers in well know processes and can be tailored in order to give them the desired properties. The monomers used for the polymerisation to polymers used for the making of the fibres (which are used to make yarns being woven to airbag fabric) are nowadays made from fossil based raw material, namely petroleum or natural gas. In the following these monomers are called fossil based monomers.

The basic idea of this invention is that the production of an airbag consumes less fossil resources if at least a part of the monomers are being produced from a renewable material. In the following these monomers are called sustainable based monomers.

Though the basic structure and the properties of the airbag skin remain Unchanged—it can still be a fabric being woven from a plastic material—the consumption of fossil raw materials such as petroleum or natural gas can at least be reduced.

Because the requirements regarding the tensile strength, the heat resistance are very demanding for airbag skin fabrics, it may not be possible or feasible to use only polymers made only from sustainable based monomers. But according to one important aspect of the invention it is possible to mix sustainable based monomers and fossil based monomers. In the case of a woven fabric, there are three basic concepts for this as described as follows.

As has already been mentioned, the structure of a woven airbag fabric can be described as having three levels. The first level is the structure of the fabric itself. It is woven from weft threads and warp threads. The weft threads and the warp threads are usually yarns which consist of a plurality of fibres (second level). And finally the fibres consist of a polymer consisting of a large number of monomers (third level).

The mixing of sustainable based monomers and fossil based monomers can be done in any of the these three levels:

Starting with the microscopic third level: It is possible to manufacture polymers by the polymerisation of two or more different monomers. Such polymers are called copolymers. A “traditional” copolymer is for example polyester. In the case discussed here, at least one kind of fossil based monomers and one kind of sustainable based monomers are used. In the simplest structure the copolymer chain can contain fossil based monomers and sustainable based monomers in an alternating way. If the fossil based monomers and the sustainable based monomers have the same atomic weight and the complete airbag skin is made of such a copolymer, half of the fossil raw material can be saved. A copolymer containing sustainable bases monomers and fossil based monomers is here referred to as mixed copolymer. A fibre consisting of such a mixed copolymer is referred to as mixed fibre.

An alternative way to get a mixed fibre is as follows. First two polymer masses are separately made by the polymerisation of monomers. The first polymer mass is manufactured by the polymerisation of sustainable based monomers and the second polymer mass is manufactured by the polymerisation of fossil based monomers. These two polymer masses are blended, melted and extruded so that a mixed—or one could also say blended—polymer mass is formed. This blended polymer mass contains polymer chains made exclusively from sustainable based monomers and polymer chains made exclusively from fossil based monomers. Such a mixed polymer mass can also easily be used for the fabrication of foils.

The mixture of sustainable based monomers and fossil based monomers can also take place in the next, namely the second level. It is possible to make first fibres being made of a first polymer being exclusively made from sustainable based monomers and second fibres being made form a second polymer being exclusively made from fossil based monomers. A yarn can be made of these two kinds of fibres, for example half of the fibres of a yarn can be first fibres and half of the fibres can be second fibres. A yarn being made of first fibres and second fibres is referred to as mixed yarn.

On the largest scale the mixing of fossil based monomers and sustainable based monomers takes place when the yarns are woven to a fabric. It is especially possible that one uses first yarns being exclusively made of first fibres being exclusively made of polymers being made by polymerisation of sustainable based monomers and second yarns being exclusively made of second fibres being exclusively made of polymers being made by polymerisation of fossil based monomers. In this case the “mixing” of sustainable based monomers and fossil based monomers does not take place before the weaving of the fabric. A fabric of this kind is referred to as a mixed fabric.

Of course, the three possibilities of mixing can be combined with one another. In other words: what is described above is a mixing of fossil based materials and sustainable based materials in only one level, but it is also possible to have a multi-level-mixing. Further it may in some applications be possible to use only sustainable based monomers in the production for the fibres used in an airbag fabric.

Many renewable raw materials can be used as basis for the production of sustainable based monomers, especially sunflower oil, rape seed, corn starch, and polylactic acid. The raw material can also be produced by microbes, yeasts or enzymes.

The three kinds of mixing will now again be explained in view of the figures.

### BRIEF DESCRIPTION OF THE DRAWINGS

FIG. 1 shows an airbag;

FIG. 2 shows the detail D1 of FIG. 1, namely a section of the fabric of the outer skin of the airbag;

FIG. 3 shows the detail D2 of FIG. 2, namely a section of a yarn;

FIG. 3a shows a sectional view along line A-A in FIG. 3;

FIG. 4 shows the detail D3 of FIG. 3, namely a section of a fiber in a very schematic representation;

FIG. 5 shows a mixed fiber in a representation according to FIG. 4;

FIG. 6 shows a mixed yarn in a representation according to FIG. 3a;

FIG. 7 shows a mixed fabric in a representation according to FIG. 2; and

FIG. 8 shows a fiber being made from a blended polymer mass in a representation according to FIG. 4.

### DETAILED DESCRIPTION OF PREFERRED EMBODIMENTS

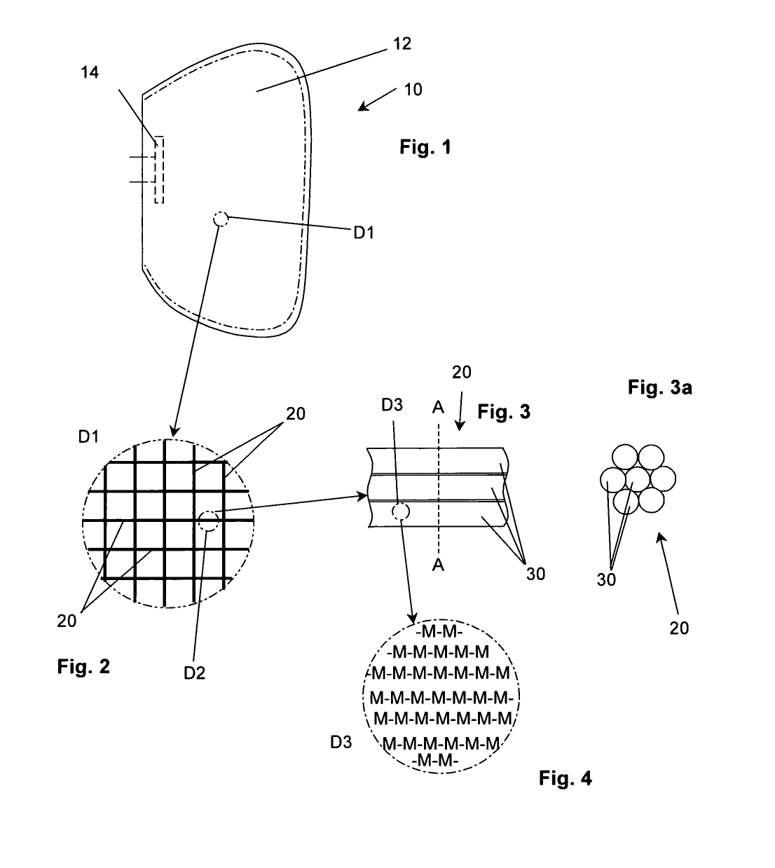

FIG. 1 shows an airbag 10, namely a side airbag. The airbag comprises an airbag skin 12 enclosing a gas chamber. A gas generator 14 can be located inside said gas chamber. The airbag skin 12 is made of fabric being woven of yarns 20 as shown in FIG. 2. Each yarn 20 in turn consists of a plurality of fibres 30 as is shown in FIGS. 3 and 3a. The fibres 30 consists of polymers as is schematically shown in FIG. 4. Here each “M” represents a monomer and each “—” represents a bond between two monomers. The bonds are built up during the polymerisation process to create polymer chains.

FIG. 5 shows a first possibility how sustainable based monomers “S” and fossil based monomers “F” can be mixed, namely by polymerisation of these types of monomers to mixed copolymers. The fibre made from such a mixed copolymer is a mixed fibre. A section of such a mixed fibre is shown in FIG. 5.

FIG. 6 shows a mixed yarn 25. It is comprised of first fibres 31 (being made of polymers polymerised from sustainable based monomers) and second fibres 32 (being made of polymers polymerised from fossil based monomers).

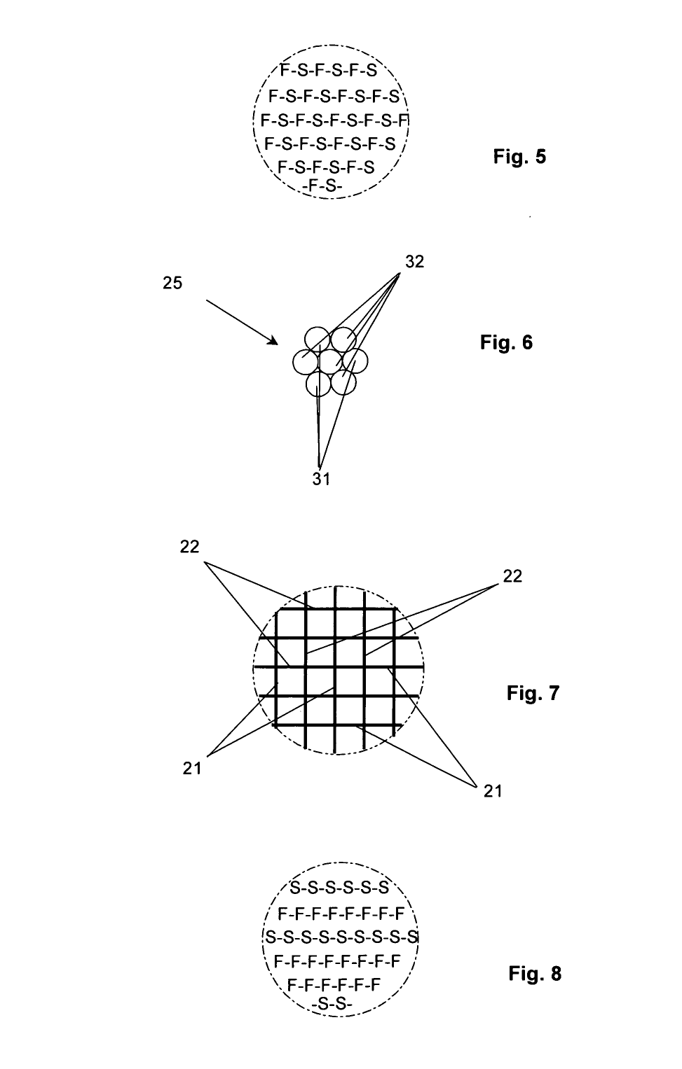

FIG. 7 shows a mixed fabric being woven from first yarns comprising only first fibres and second yarns comprising only second fibres. Depending on the requirements, both, the weft and the warp threads can—for example in an alternating pattern as shown in FIG. 7—be first and second yarns, respectively. Other designs are possible.

FIG. 8 shows a section of a fibre being extruded from a blended polymer mass. This polymer mass contains polymer chains being polymerised from sustainable based monomers: —S—S—S—S—S— and polymer chains being polymerised from fossil based monomers: —F—F—F—F—.

The invention has been described by means of a preferred embodiment, namely an airbag with a woven airbag skin whose warp and weft threads are yarns. But it needs to be emphasised that the use of sustainable based monomers for the manufacture of airbag skin material can also be applied to other kinds of airbag skin materials made of polymers, like plastic foil materials, knitted or other non-woven materials.

While the above description constitutes the preferred embodiment of the present invention, it will be appreciated that the invention is susceptible to modification, variation and change without departing from the proper scope and fair meaning of the accompanying claims.

1. An airbag having an outer skin enclosing at least one gas chamber, comprising the outer skin being made at least in parts of a first polymer material with polymers of the first polymer material being made by polymerisation of monomers, wherein at least a part of the monomers are sustainable based monomers produced from a renewable raw material.

2. An airbag according to claim 1, further comprising in that the sustainable based monomers constitute at least 10% of the weight of the outer skin.

3. An airbag according to claim 1, further comprising in that the sustainable based monomers constitute at least 30% of the weight of the outer skin.

4. An airbag according to claim 1 further comprising in that the airbag outer skin further contains second polymer material produced by polymerisation of fossil based monomers.

5. (canceled)

6. An airbag according to claim 1 further comprising in that at least a part of the outer skin is a woven fabric.

7. An airbag according to claim 6, further comprising in that the woven fabric is woven from yarns.

8. An airbag according to claim 7 further comprising in that at least a part of the yarns contains fibers being completely made of the first polymer material and another part of the yarns contains fibers being completely made of a second polymer material being made from fossil based monomers the fibers intertwined with the yarns.

9. An airbag according to claim 4 further comprising in that the fabric comprises first yarns being made of the first polymer material and second yarns being completely made of the second polymer material.

10. An airbag according to claim 7, further comprising in that at least a part of yarns of the fabric contains fibers made of the first polymer material and partially of the second polymer material.

11. An airbag according to claims 1 further comprising in that at least a part of the airbag outer skin is knitted or non-woven.

12. An airbag according to claim 1 further comprising in that the airbag outer skin is at least in part made from a blended polymer mass which is blended from a first polymer mass being formed of the first polymer material and a second polymer mass being formed of the second polymer material.

13. An airbag according to claim 1 further comprising in that the renewable raw material is at least one of sunflower oil, rape seed, corn starch, and polylactic acid.

14. An airbag according to claims 1 further comprising in that the renewable raw material is produced by at least one of microbes, yeasts, or enzymes.
